(19) United States
(12) Patent Application Publication
(10) Pub. No.: US 2007/0180937 A1
(43) Pub. Date: Aug. 9, 2007

(54) Railway safety apparatus

(76) Inventors: Ian Robert Thomson, St Neots (GB); Peter Dooley, Otford (GB)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/597,026

(22) PCT Filed: Jan. 10, 2005
(86) PCT No.: PCT/GB05/50006

§ 371 Date: Jul. 7, 2006

(30) Foreign Application Priority Data
Jan. 8, 2004 (GB) 0400324.0

(51) Int. Cl. G01M 19/00; F16B 31/02

(52) U.S. Cl. 73/865.9; 403/27; 411/8

(57) ABSTRACT

A system for inspecting rail tracks for loose connections (4, 7) employs moulded plastic caps (8). The caps carry arrows (9) or other indicators aligned with a datum direction such as the direction of the rails.

Any loosening of the connectors (4, 7) is immediately apparent from the fact that the arrows are no longer aligned. The invention avoids the need for individual manual torquing of each connector during routine safety inspections.

This invention relates to railway safety apparatus.

Each rail of a railway track is normally fastened to an adjacent rail, or to points, by a series of nuts and bolts. The rails are fixed to sleepers by a bracket, which is secured to the sleeper with a bolt or screw. Because the rails are subjected to regular violent vibration caused by the passage of trains over them, loosening of these nuts, bolts and screws inevitably occurs. Checking their tightness is therefore an essential part of any railway maintenance routine and the effectiveness with which such checks are made is directly related to the avoidance of serious accidents. These checks have, up till now, generally been performed by walking along the track, fitting a spanner to each and every nut, bolt and screw, and turning, if necessary, until it is tight. Many fatal accidents in recent years have been attributed to the impracticability of performing this operation.

Sometimes, superficial visual inspections are carried out from off-road vehicles driven along the track, but this technique can only detect faults which are so evident that they will already have become a serious danger. It cannot detect the development of a fault in its early stages.

It has been proposed, in an entirely different technical field, namely that of commercial road vehicles, to fit pointers onto the vehicle's wheel nuts so that loosening of those nuts will become apparent from the direction of the pointer. This technique is described in patent specification GB2242720.

This invention arose from a realisation that the aforementioned technique, previously used only in relation to commercial road-vehicle wheel nuts, could be applied to the detection of looseness of screw-threaded connectors in railways.

Accordingly, the invention provides railway safety apparatus for detecting looseness of a screw-threaded connector characterized by a rotation indicator associated with the connector so as to indicate rotation from a correctly tightened position.

In its simplest form, the rotation indicator is a mark on the nut, bolt, screw or other screw-threaded connector. This enables relatively unskilled railway maintenance personnel to walk along the railway track noting the positions of such marks and to tighten any connectors which are not pointing in a predetermined datum direction.

The marks may be in the form of an arrow or a pointer set to point in a pre-determined direction. This will normally be parallel to the rail because the latter provides a perfect datum direction in relation to which rotation can be noted. However, the marks may be set to some other datum direction e.g. perpendicular (pointing either up or down). Another possible datum direction is normal to the rail.

Although it is possible to use a simple mark on the connector, a preferred technique is to form the indicator as part of a separate element which can be fitted onto the connector after the latter has been tightened to the correct torque. In this way the need for optimum tightness is not compromised by the need to ensure that the marker points in a pre-assigned direction after tightening.

The indicator element is preferably of moulded synthetic plastics material. In one embodiment, it takes the form of a cap which serves an ancillary function of covering the connector and preventing ingress of dirt. The cap is preferably formed with internal grooves designed to receive corners of the connector (normally the connector will be a multi-sided nut or screw-head). The pitch between these grooves is preferably relatively small, i.e. there are more grooves than there are corners of the nut or screw head. This allows fine adjustment of the rotational position of the indicator.

As previously mentioned, use of the invention can greatly simplify the task of manual inspection. However, the invention also makes it possible to reduce or even eliminate the need for manual inspections by using a mobile detector to sense, auto-matically, the position of rotation of each indicator and to alert a responsible person when rotation of any connector beyond a preset angular threshold value is detected. The mobile detector can be designed to travel along the railway track. It can be fitted to trains and, in this way; automatic checking for faults will take place whenever the railway line is used, without the need to interrupt scheduled services. Furthermore, the frequency of such checks increases with the use of the line and therefore with the likelihood of a fault developing.

Where an automatic detector is used, this could employ an optical technique to inspect the position of rotation of the visible rotation indicators. However, there are many other possibilities. For example, loosening of a nut could be arranged to trigger a transmission, e.g. a radio transmission, or to set a transponder to a condition where it would indicate rotation or looseness when interrogated by an inspection unit. Another possibility would be for rotation of the indicator to be detected using gravity, (e.g. using a mercury-operated switch) or magnetic field.

The use of a transmitter or transponder in this way is considered to have in-dependent inventive significance and therefore, according to a second aspect of this invention there is provided a railway safety system for detecting looseness in screw-threaded connectors, the system comprising a transmitter or responder associated with a connector and arranged to give a signal indicating looseness.

In another variation of the invention the indicator emits a thermal signal when rotation takes place. This is achieved by incorporating, in the indicator, two com-partments containing different chemicals selected to produce an exothermal reaction when mixed. By suitable design of the compartments, the chemicals are kept separate when the indicator is correctly positioned; but mix or spill, one into the other, when rotation through more than a preset threshold angle occurs. This latter technique is considered particularly beneficial because certain railway systems are regularly inspected by thermal imaging equipment from aircraft. The purpose of these in-spections has previously been to check the functioning of anti-iceing heaters associated with railway points. However, such inspections will now be able also to detect faulty connectors equipped with a thermal device as described above.

One way of carrying out the invention will now be described by way of example with reference to the accompanying drawings in which:

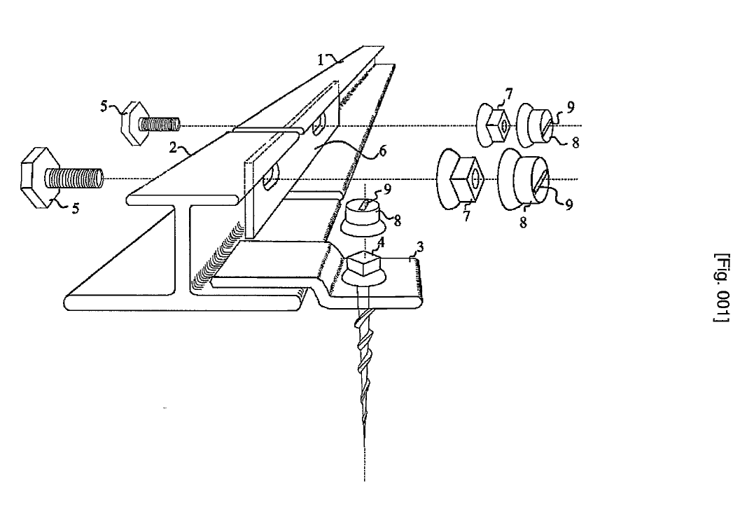

FIG. 1 is a schematic perspective view of a connection between two rails of a railway system fitted with rotation indicators constructed in accordance with the invention;

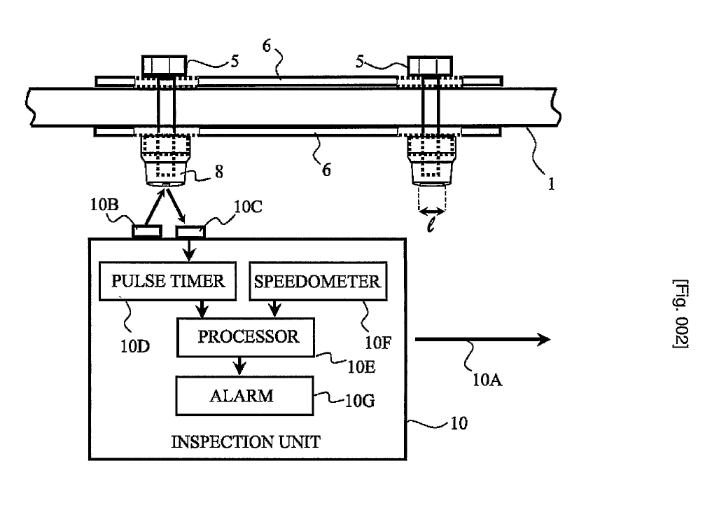

FIG. 2 is a schematic illustration of an automatic detector being used in the system shown in FIG.1;

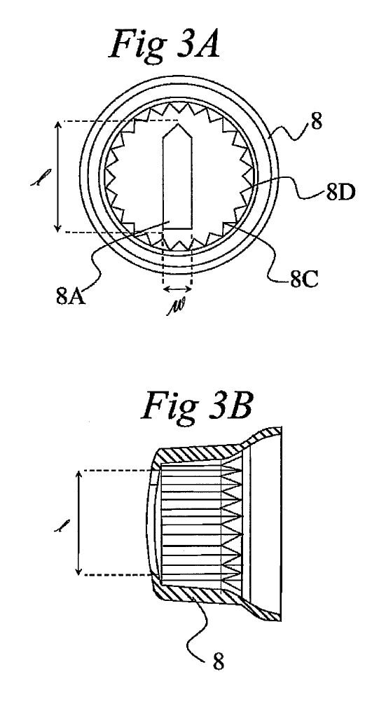

FIG. 3A is an end elevation of an indicator cap (also shown in FIGS. 1 & 2) as seen from its open end after a first moulding stage but before the second;

FIG. 3B is a cross section through an axial vertical plane of FIG. 3A;

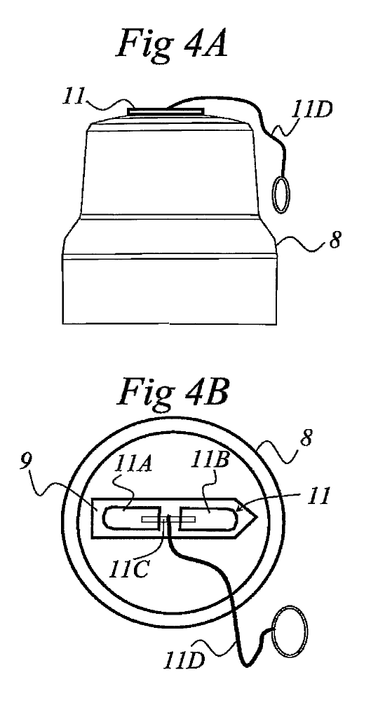

FIG. 4A is a side elevation of an indicator cap similar to that of the previous drawings but adapted to emit a thermal signal; and

FIG. 4B is an end elevation of the cap of FIG. 4A as seen from its closed end.

Referring firstly to FIG.1 there is shown a junction between two rails 1 and 2 of a railway system. For the purposes of this example, the rail 2 is assumed to be part of a “points” system. The rails are anchored to the ground by sleepers (not shown) extending laterally with respect to the rails. This is done by brackets, like that shown at 3, secured to a sleeper by a square headed screw 4. This particular rail track is assumed to use wooden sleepers and the screw 4 is therefore formed as a wood-screw.

The rails 1 & 2 are connected together end to end, with a gap between them to allow expansion. The connection is made by bolts 5 which pass through holes (not shown), in the vertical walls of the rails. The bolts 5 also pass through elongated holes in two fishplates 6 (only one shown) and are secured by nuts 7.

During initial installation of the track, or during a routine maintenance operation on an existing track, the screw 4 and nuts 7 are tightened by hand, using a large spanner, to a torque estimated as being suitable by the particular person carrying out the operation. In accordance with the invention, caps 8 are then fitted onto each screw and nut. Each cap 8 carries an arrow 9 and the caps are oriented so that the arrows associated with nuts 7 point in the direction of the rails. This particular orientation can be varied according to choice; it being necessary only that a predetermined direction should be decided for consistent use throughout a particular rail network. In this particular embodiment of the invention, the arrows 9 are retro reflective, but in other embodiments they could be of other visually distinctive material.

FIG. 2 shows, very schematically, a mobile inspection unit 10 fixed to a train (not shown) travelling in the direction of arrow 10A along the railway track of FIG. 1. The inspection unit 10 has a light emitter 10B which directs a beam of light horizontally towards the rails. When the inspection unit passes a cap 8, light from the source 10B is reflected back by retro reflective material of the arrow 9 (FIG. 1) and is detected by a detector 10C. This produces a pulse, the duration of which is normally equal to the ratio of the arrow width w divided by the train speed. However, the apparent width of the arrow 9 decreases with any rotation away from the horizontal, i.e. with any mis-alignment from the rail direction. Thus, the pulse length is dependant on the angle of rotation. This pulse length is measured at 10D and a processor 10E makes an adjustment for the train speed as measured at 10F. When an arrow has rotated through 90 degrees, as shown on the cap to the left-hand side of FIG. 2, the pulse length will be relatively short (equal to the ratio of the length 1 divided by the train speed). When the processor 10E detects a ratio of less than some preset safety threshold it causes an alarm 10G to operate.

The cap 8 is shown in greater detail in FIGS. 3A & 3B. It is made from black Actyl Butyl Styrene (ABS), a thermoplastic synthetic rubber, and is selected to have a softness of 60 to 70 shore. This allows the cap to fit comfortably and resiliently onto nuts and screw heads of slightly varying sizes with a good interference fit. The cap is made using a two shot injection moulding process. During the first part of this process the main body of the cap is made with an arrow shaped aperture 8A as shown in FIG. 3a. During the second part of the moulding process a harder thermoplastic, in white or other bright colour, is moulded into the arrow shaped aperture to provide a permanent marker 9 that cannot be removed. Where an automatic detection unit is to be used as shown in FIG. 2, retro-reflective material is included into material forming this arrow. The interior cylindrical surface of the cap is formed with twenty-four teeth 8C, with grooves 8D in-between to receive the corners of nuts or screw-head. This allows a fine adjustment of the rotational position of the cap. In an alternative construction (not shown), the arrow or equivalent marker is provided on a separate component, rotatably mounted relative to the body of a cap having a relatively small number of grooves. After fitting this cap, the rotatable component is turned so that the arrow points in the desired direction.

Another variation is shown in FIGS. 4A & 4B. This construction is similar to that of FIGS. 3A & 3B except that a thermal emitter 11 is fitted onto the arrow 9 (in an al-ternative arrangement it could be fitted alongside the arrow. The thermal emitter 11 comprises two containers 11A & 11B connected by a linking tube 11C. This tube 11C defines a channel which is normally blocked by a plastic membrane (not shown). When the cap 8 has been fitted onto a nut or screw head, the cap is “primed” by pulling a cord 11D, rupturing the membrane. Thereafter, rotation of the cap from its horizontal position allows the different chemicals in containers 11A & 11B to mix. The resulting exothermal reaction emits heat for at least a 24-hour period; sufficient to allow detection during the next routine inspection from an airborne thermal detector.

In yet another variation, the chemicals in the containers 11A and B are selected to cause fluorescence when mixed.

The technique described above for creating an exothermic or fluorescent reaction is also considered to have independent inventive significance and therefore, according to a third aspect of this invention there is provided a screw threaded connector comprising means for containing separately two chemicals which, when mixed, emit thermal or visible radiation; and means for causing such mixing in response to undesired loosening of the connector.

It will be readily apparent that many other variations are possible within the scope of the accompanying claims. However, whichever construction is employed, it is believed that the invention will, by enabling reliable inspection of railway tracks to be performed with realistically available resources, make a significant contribution to ongoing efforts for the elimination of serious rail disasters.

1. A railway safety apparatus for detecting looseness of a screw-threaded connector characterized by a rotation indicator associated with the connector so as to indicate rotation from a correctly tightened position.

2. Apparatus according to claim 1 characterised in that the indicator is attached to the connector so that it rotates with it.

3. Apparatus according to claim 1 characterized in that the rotation indicator is a moulded component of synthetic plastics material that fits onto the connector.

4. Apparatus according to claim 2 characterised in that the rotation indicator is in the form of a cap that fits over the connector.

5. Apparatus according to claim 3 characterised in that: the connector has a polygonal shape defining corners between the sides of the polygon, the rotation indicator has internal groves adapted to receive the corners, and the number of grooves is greater than the number of corners so as to allow relatively fine adjustment of the position of rotation of the indicator relative to the connector.

6. Apparatus according to claim 1 characterised by visible indicia on the indicator allowing a human inspector to detect visually any significant rotation of the connector from a datum position.

7. Apparatus according to claim 6 characterised in that the rotation indicator is adapted to co-operate with a mobile detector, the mobile detector being designed to inspect a rail-track and to detect rotation indicators which have undergone an undesired rotation.

8. Apparatus according to claim 7 characterized in that the mobile detector is mounted on a rail vehicle.

9. Apparatus according to claim 7 characterized in that the mobile detector is carried by an aircraft.

10. Apparatus according to claim 7 characterized in that the indicator carries a transmitter or transponder for transmitting a signal indicating whether the connector has experienced undesirable rotation.

11. Apparatus according to claim 10 characterized in that the transmitter carried by the indicator is adapted to transmit a signal in response to an interrogation signal from the mobile detector.

12. Apparatus according to claim 1 characterised in that the indicator is adapted to transmit a heat signal in response to rotation of the connector.

13. Apparatus according to claim 12 characterised in that the indicator carries two chemicals which, when mixed, react exothermally, the indicator including means for allowing the chemicals to mix in response to rotation.

14. A rotation indicator for use in a railway safety system comprising the apparatus of claim 1.

15. A mobile detector for use in a railway safety system according to claim 7.

16. A railway safety system for detecting looseness in screw-threaded connectors, the system comprising a transmitter or responder associated with a connector and arranged to give a signal indicating looseness.

17. A screw threaded connector comprising means for containing separately two chemicals which, when mixed, react in such a way as to emit thermal or visible radiation; and means for causing such mixing in response to undesired loosening of the connector.

18. (canceled)
